(19) United States
(12) Patent Application Publication
(10) Pub. No.: US 2011/0222263 A1
(43) Pub. Date: Sep. 15, 2011

(54) HIGH TRANSMISSION FLUX LEVELING MULTILAYER OPTICAL FILM AND RELATED CONSTRUCTIONS

(76) Inventors: Michael F. Weber, Shoreview, MN (US); Timothy J. Nevitt, Red Wing, MN (US); Stephen A. Johnson, Woodbury, MN (US); Yufeng Liu, Woodbury, MN (US); David T. Yust, Woodbury, MN (US)

(21) Appl. No.: 13/129,468

(22) PCT Filed: Nov. 17, 2009
(86) PCT No.: PCT/US09/64674

§ 371 Date: May 16, 2011

Related U.S. Application Data
(60) Provisional application No. 61/116,132, filed on Nov. 19, 2008.

(51) Int. Cl. F21V 9/14; G02B 5/30

(52) U.S. Cl. 362/19; 359/485.01

(57) ABSTRACT

A reflective film includes microlayers arranged into optical repeat units, each optical repeat unit including a negatively birefringent microlayer. The microlayers are tailored to provide the film with on-axis polarizing properties, such that normally incident light polarized along a block axis is substantially reflected and normally incident light polarized along a pass axis is substantially transmitted. On-axis transmission for the block axis may be <20%, and on-axis transmission for the pass axis may be >70%. The microlayers also provide the film with angularly dependent polarizing properties: p-polarized light incident in a block plane of incidence is substantially reflected at near-normal angles but substantially transmitted at an oblique angle. The film transmits unpolarized light incident in this plane more strongly at the oblique angle than at normal. The films can be used in direct-lit backlights, luminaires, and similar lighting systems for flux leveling to promote spatial brightness uniformity.

### FIELD OF THE INVENTION

This invention relates generally to optical films, with particular application to such films whose reflection characteristics are determined in large part by constructive and destructive interference of light reflected from interfaces between microlayers within the film. The invention also relates to associated systems and methods.

### BACKGROUND

Reflective polarizers composed of a plurality of microlayers whose in-plane refractive indices are selected to provide a substantial refractive index mismatch between adjacent microlayers along an in-plane block axis and a substantial refractive index match between adjacent microlayers along an in-plane pass axis, with a sufficient number of layers to ensure high reflectivity for normally incident light polarized along the block axis while maintaining low reflectivity and high transmission for normally incident light polarized along the pass axis, have been known for some time. See, e.g., U.S. Pat. Nos. 3,610,729 (Rogers), 4,446,305 (Rogers et al.), and 5,486,949 (Schrenk et al.).

More recently, researchers from 3M Company have pointed out the significance of layer-to-layer refractive index characteristics of such films along the direction perpendicular to the film, i.e. the z-axis, and shown how these characteristics play an important role in the reflectivity and transmission of the films at oblique angles of incidence. See, e.g., U.S. Pat. No. 5,882,774 (Jonza et al.). Jonza et al. teach, among other things, how a z-axis mismatch in refractive index between adjacent microlayers, more briefly termed the z-index mismatch or Δnz, can be tailored to allow the construction of multilayer stacks for which the Brewster angle—the angle at which reflectance of p-polarized light at an interface goes to zero—is very large or is nonexistent. This in turn allows for the construction of multilayer mirrors and polarizers whose interfacial reflectivity for p-polarized light decreases slowly with increasing angle of incidence, or is independent of angle of incidence, or increases with angle of incidence away from the normal direction. As a result, multilayer films having high reflectivity for both s- and p-polarized light for any incident direction in the case of mirrors, and for the selected direction in the case of polarizers, over a wide bandwidth, can be achieved.

### BRIEF SUMMARY

We describe herein, among other things, a multilayer optical film that includes microlayers arranged into optical repeat units. The microlayers are tailored to provide the film with strong on-axis polarizing properties, such that normally incident light polarized along a block axis is substantially reflected and normally incident light polarized along a pass axis is substantially transmitted. For example, the film can have an average on-axis transmission for normally incident visible light polarized along the block axis of <20 or 10%, and an average on-axis transmission for normally incident visible light polarized along the pass axis of >70, 80, or 90%. Each optical repeat unit includes at least one microlayer that is negatively birefringent, and the microlayers are further tailored to provide the film with strong angularly dependent polarizing properties, such that p-polarized light incident in a block plane of incidence is substantially reflected at near-normal angles but substantially transmitted at an oblique angle accessible in air. For example, the film can have an average transmission for p-polarized visible light incident in the block plane of <20 or 10% for a near-normal incidence angle, and of >80 or 90% for a particular oblique angle of incidence. Alternatively, the film may have an average transmission, for unpolarized light incident at a large oblique angle in a block plane that includes the block axis, that is greater than the average transmission for normally incident unpolarized light.

Such a film thus provides two distinct polarizing characteristics: (1) for on-axis performance, the film separates one polarization state from an orthogonal polarization state by preferentially reflecting light polarized along the block axis; and (2) for angular performance, the film separates, as a function of incidence angle, p-polarized light incident in a plane that includes the block axis by strongly reflecting such light incident at near-normal angles and strongly transmitting such light incident at a particular large oblique angle. This combination of features is counterintuitive, since ordinarily one would expect a film that is a good polarizer at normal incidence, strongly reflecting light polarized along the block axis and strongly transmitting light polarized along the pass axis, to maintain these characteristics to the extent possible for oblique incidence, rather than to take on a completely different characteristic at oblique angles, namely, strong transmission of highly oblique p-polarized light incident in a plane that includes the block axis.

Such a film also preferably provides an overall light transmission that is higher, and an overall light reflectivity that is lower, than that of typical multilayer mirror films, while also exhibiting a substantial off-axis transmission preference or “light leakage” for unpolarized light when incident in a first plane of incidence but not when incident in an orthogonal second plane of incidence. For example, the film may exhibit a hemispherical reflectivity in a range from 40 to 60%, or from 45 to 55%, and a hemispherical transmission in a range from 40 to 60%, or from 45 to 55%, preferably when averaged over visible wavelengths or a similar extended wavelength range. The film may also exhibit an average transmission for unpolarized light of Tnorm-unpol for such light incident normally on the film, and the average transmission may then increase relative to this value with increasing incidence angle along a first plane of incidence to a maximum value Toblique-unpol at a particular polar angle θoblique, but decrease with increasing incidence angle along a second plane of incidence. Tnorm-unpol may be in a range from 30% to 70%, or from 40% to 60%, and the ratio of Toblique-unpol/Tnorm-unpol is greater than 1 and in exemplary embodiments may be at least 1.4, 1.5, or 1.6.

The off-axis light leakage makes the film suitable for use in direct-lit backlights and similar lighting systems in which the film can be placed in front of the lamp(s), with or without other intermediate optical films or bodies, in order to help disperse light emitted by the lamp(s) for better spatial uniformity and to help hide or obscure the lamp(s). The film can also be used in general illumination systems such as luminaires and task lighting to provide a balance of on-axis and off-axis illumination to help broaden the angular distribution of the output light for reduced glare or other desired design objectives.

Because of the asymmetric nature of the light leakage, the film is well suited for use with linear light sources, i.e., a light source that extends physically along a light source axis and is much shorter or confined along other axes perpendicular to the light source axis. A straight tubular fluorescent bulb is one example of such a source, and a plurality of individual LEDs arranged in a line is another example. The film can be beneficially oriented such that the block axis of the film is substantially perpendicular to the light source axis.

The disclosed reflective films can be made to have low absorption losses in the visible region or other wavelength region of interest, so that nearly all such light that is not transmitted by the film is reflected by the film, and vice versa, or Rhemi+Themi≈100%, where Rhemi refers to the total hemispherical averaged reflectivity of the film, and Themi refers to the total hemispherical averaged transmissivity of the film. As such, the disclosed films can advantageously be used in lighting systems that employ light recycling. A disclosed film may for example be placed in a direct-lit system with a back reflector and one or more lamps disposed between the back reflector and the film. Light that is not initially transmitted by the film can be reflected by the back reflector back towards the film for another opportunity to be transmitted. The relatively high overall transmission of the disclosed films make them particularly well suited for use with relatively high loss lighting systems such as inexpensive fluorescent-bulb lit luminaires and the like.

The reflectivity and transmission values referred to herein as being associated with the multilayer optical film can be construed to incorporate the effects of two, or one, or zero film/air interfaces, unless otherwise noted. The question of how many such film/air interfaces to include may depend on the intended application of the disclosed reflective films. For example, if the film is to be placed in an existing backlight, luminaire, or other lighting system, and if the outer major surfaces of the film will remain exposed to air rather than be brought into close optical contact (e.g. by lamination) with another optical element, then the system designer may wish to include the effects of both film/air interfaces in reflectivity and transmission to assess the impact of the reflective film on the system. On the other hand, if a prismatic film is first laminated to one major surface of the reflective film and then the combination is placed in an existing lighting system, then the system designer may wish to include the effects of only one film/air interface—that of the unlaminated major surface of the reflective film. Finally, if the reflective film is to be laminated to an existing component of a lighting system, the existing component having a refractive index similar to that of the outer surfaces of the film, the system designer may wish to include no film/air interfaces in the reflectivity and transmission values in view of the fact that the addition of the reflective film to the system leaves the overall number of polymer/air interfaces in the system substantially unchanged.

Related methods, systems, and articles are also discussed.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a schematic perspective view of a lighting system that includes a high transmission flux leveling film;

FIGS. 2a and 2b are schematic side views of the lighting system of FIG. 1 along orthogonal viewing directions;

FIG. 3 is a perspective view of a portion of a multilayer optical film;

FIGS. 3a-d depict exemplary refractive index relationships that can be used to help achieve the desired reflectivity and transmission characteristics of the multilayer optical film;

FIG. 4 is a perspective view of an ideal polarizing film, demonstrating the difference between a fixed x, y, z Cartesian coordinate system on the one hand and s- and p-polarization directions on the other hand, the latter of which are dependent on the plane of incidence of the light and thus unspecified with respect to the x, y, and z axes unless one specifies the plane of incidence of the light;

FIG. 4a is a perspective view of the Cartesian coordinate axes x, y, z, showing with respect thereto the polar angle θ and the azimuthal angle φ of an arbitrary point or vector;

FIGS. 5a and 5b are graphs of calculated reflectivity vs. incidence angle for a particular high transmission flux leveling film embodiment, where FIG. 5a shows calculated reflectivity for orthogonal s- and p-polarization states for light incident in a block plane of incidence, and FIG. 5b is similar but for light incident in a plane perpendicular to the block plane, and both FIGS. 5a and 5b include the reflective contribution of two air/film surfaces;

FIG. 6a is the same graph as that of FIG. 5a, but also showing the average reflectivity for unpolarized light based on the s- and p-polarization data;

FIG. 6b is a graph similar to that of FIG. 6a, except that the effects of the two film/air interfaces have been removed from the calculated reflectivity values;

FIG. 7 is a schematic side view of another lighting system that includes a high transmission flux leveling film;

FIG. 8 is a graph of measured transmission vs. wavelength for a reflective multilayer optical film that was fabricated and tested;

FIG. 9 is a graph of measured photopic intensity vs. position for a direct-lit backlight system, demonstrating the flux-leveling properties of the disclosed films;

FIG. 10 is a graph of calculated reflectivity vs. incidence angle for a high transmission flux leveling film immersed in a material of refractive index 1.2; and

FIG. 11 is a graph of measured reflectivity vs. incidence angle in air for various lighting system components, namely, a volume diffuser plate alone, a multilayer optical film laminated to the diffuser plate, and both the multilayer optical film and a beaded gain diffuser film laminated to the diffuser plate.

In the figures, like reference numerals designate like elements.

### DETAILED DESCRIPTION OF ILLUSTRATIVE EMBODIMENTS

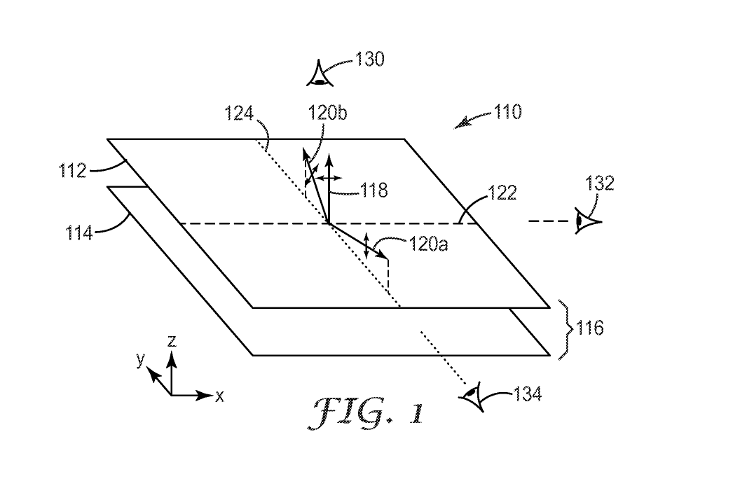

FIG. 1 depicts a simplified perspective view of a lighting system 110 that utilizes a reflective multilayer optical film 112 configured as a high transmission flux leveling film. The system 110 also includes a high reflectivity back reflector 114 which is substantially coextensive with and opposed to multilayer optical film 112 so as to form a light recycling cavity 116 therebetween. Thus, light reflected by the film 112 can be reflected again by back reflector 114 towards the film 112 for another opportunity to be transmitted for improved system efficiency and reduced losses.

The multilayer optical film 112, or high transmission flux leveling film, is shown transmitting light along a surface normal or z-direction, see ray 118, and light propagating at large oblique angles, see rays 120a, 120b. These rays 118, 120a-b are an oversimplification of the actual transmission of actual multilayer optical films described further below, but are useful to demonstrate the important characteristics of the films. Small double-sided arrows are included with the depicted rays to represent their respective polarization states. Also, a Cartesian x-y-z coordinate system is shown for reference purposes. Film 112 is depicted as substantially flat and planar, extending parallel to the x-y plane and having a surface normal parallel to the z-axis. Lighting systems are also contemplated in which the film 112 may be curved or bent to conform to a desired shape, but even in those cases the film 112 can be considered to be locally flat and planar over small areas. In such cases, FIG. 1 may be considered to represent a small localized portion of a larger lighting system.

The multilayer optical film 112 possesses an in-plane pass axis 122 aligned with the x-axis and an in-plane block axis 124 aligned with the y-axis, thus behaving in some respects as a reflective polarizer. Light impinging on the film 112 from behind, if directed along the z-axis and if polarized parallel to the pass axis 122, is strongly transmitted to produce output ray 118. Light directed along the z-axis and polarized parallel to the block axis is strongly reflected and is thus not represented by ray 118 since it is not substantially transmitted. Light impinging on the film from behind at oblique angles, if polarized along the pass axis 122, is transmitted to a lesser extent than the normally incident light, generally experiencing reduced transmission and increased reflectivity with increasingly oblique angles, and is thus not depicted in the figure. However, light whose incident direction lies in the y-z plane, which includes block axis 124 and can thus be referred to as a block plane of incidence, and if polarized in the same y-z plane, experiences decreasing reflectivity and increasing transmission with increasing incidence angle until a maximum is achieved at a large incidence angle θoblique, producing output rays 120a, 120b. Preferably, for light incident in the y-z plane, as the incidence angle deviates from the normal direction, the decrease in reflectivity of the light polarized in the plane of incidence (p-polarized light) is stronger than the increase in reflectivity of the light polarized perpendicular to the plane of incidence (s-polarized light), such that the average reflectivity for unpolarized light incident in the y-z plane is smaller at the large oblique angle θoblique than it is at normal incidence, and thus the average transmission for unpolarized light incident in the y-z plane is greater at the large oblique angle than at normal incidence. If “Tnorm-unpol” represents the film's average transmission for unpolarized normally incident light, and “Toblique-unpol” represents a maximum in the average transmission at a particular polar angle θoblique for unpolarized light incident in the block plane of incidence, then Tnorm-unpol may be in a range from 30% to 70%, or from 40% to 60%, and the ratio of Toblique-unpol/Tnorm-unpol is greater than 1 and in exemplary embodiments is at least 1.4, 1.5, or 1.6.

This increase in transmission for unpolarized light incident in the block or y-z plane, combined with the fact that a corresponding increase in transmission does not occur for light incident in the pass or x-z plane, can be used beneficially in different lighting systems such as backlights, luminaires, and the like, for bulb-hiding purposes or to otherwise distribute light into desirable directional and spatial patterns. With such optical characteristics, the multilayer optical film can provide a flux or brightness leveling attribute along only one direction, the block axis 124, which can be used beneficially in lighting systems that employ linear light sources such as fluorescent tubes or rows of closely spaced LED or phosphor coated LEDs. In such cases, the flux-leveling direction of the film is preferably oriented to be substantially perpendicular to the axis or long dimension of the linear light source. The angle-dependent reflectivity and transmission of the film can help provide a more uniform delivery of light intensity to, for example, a front diffuser plate of a backlight or luminaire. Although the flux leveling effect is limited due to the high transmission of pass axis light (incident in the direction along the length of the linear light source), the disclosed multilayer optical films can provide a significant degree of improvement in uniformity of a lighting system with a relatively small amount of light recycling.

The foregoing properties of multilayer optical film 112 can be achieved by appropriate selection and design of a large plurality of microlayers as described in more detail below. Preferably, the microlayers and other components of the film are fabricated using low absorption materials such as low loss light transmissive polymers or other low loss materials, so that single pass absorption losses for the film are kept very low, e.g. less than 1% average over visible wavelengths. Thus, unless otherwise noted, the sum of the percent reflection and the percent transmission of a multilayer optical film, for a given wavelength, polarization state, and incidence direction, can be assumed to be nearly 100%, or at least 99%. In other words, reflectivity (%)+transmission (%)≈100%. For this reason, a decrease in reflectivity of the film can also be construed as an increase in transmission, and vice versa.

The reader who is familiar with the basic characteristics of multilayer optical films will know that a given pair of microlayers within the multilayer optical film will reflect different wavelengths of light as a function of the incidence angle of the light, and this is also the case for the multilayer optical films described herein. In some cases this property is exploited to construct “color-shifting” films that intentionally transmit or reflect different wavelengths as a function of incidence angle. However, the multilayer optical films described herein are designed to reflect and transmit light substantially uniformly over an extended wavelength band such as the human visible region from 400-700 nm, and are designed to do so over a wide range of incidence angles. This can be accomplished by providing the film 112 with a sufficient number of microlayers and a suitable layer thickness gradient, as discussed further below, to provide a wide and substantially flat reflection band. The reflection band is desirably wide enough and flat enough so that as it shifts with incidence angle and polarization, a relatively flat or uniform spectral transmission and reflectivity is maintained over the extended wavelength band. The flat spectral characteristic ensures that white light is reflected or transmitted uniformly, so that the perceived color of the reflected and transmitted light does not deviate too much from the color of the source. Where the extended wavelength band of interest is the visible spectrum, providing the multilayer optical film with a flat reflection band at normal incidence from 400 to 900 nm is often adequate, assuming the film has flat major surfaces exposed to air, to ensure uniform reflectivity from 400-700 nm over all useable angles. Alternatively, the spectral shape of the reflection band can be adjusted to provide for a specific color target using the same procedure discussed below.

The system 110 also includes the back reflector 114, but the reader will understand that the multilayer optical film 112 can also be used in lighting systems that contain no back reflector 114 and no recycling cavity 116. When included, however, the back reflector 114 may take a variety of forms depending on the intended application. In the case of a relatively inexpensive luminaire design, the back reflector may be or comprise a simple coating of white paint applied to a structural member such as a piece of sheet metal. In more demanding applications such as a backlight for an LCD TV or similar display, the back reflector 114 may have an on-axis average reflectivity of at least 90%, 95%, 98%, 99%, or more for visible light of any polarization. Such reflectivity values encompass all visible light reflected into a hemisphere, i.e., such values include both specular and diffuse reflections. In this regard, the back reflector 114 can be a predominantly specular, diffuse, or combination specular/diffuse reflector, whether spatially uniform or patterned. The back reflector 114 can also be or comprise a semi-specular reflector as described in commonly assigned PCT Patent Application Publication WO 2008/144644, “Recycling Backlights With Semi-Specular Components” (Attorney Docket No. 63032WO003), filed May 19, 2008 and incorporated herein by reference.

In some cases, the back reflector 114 can be made from a stiff metal substrate with a high reflectivity coating, or a high reflectivity film laminated to a supporting substrate. Suitable high reflectivity materials include Vikuiti™ Enhanced Specular Reflector (ESR) multilayer polymeric film available from 3M Company; a film made by laminating a barium sulfate-loaded polyethylene terephthalate film (2 mils thick) to Vikuiti™ ESR film using a 0.4 mil thick isooctylacrylate acrylic acid pressure sensitive adhesive, the resulting laminate film referred to herein as “EDR II” film; E-60 series Lumirror™ polyester film available from Toray Industries, Inc.; porous polytetrafluoroethylene (PTFE) films, such as those available from W. L. Gore & Associates, Inc.; Spectralon™ reflectance material available from Labsphere, Inc.; Miro™ anodized aluminum films (including Miro™ 2 film) available from Alanod Aluminum-Veredlung GmbH & Co.; MCPET high reflectivity foamed sheeting from Furukawa Electric Co., Ltd.; White Refstar™ films and MT films available from Mitsui Chemicals, Inc.; and one or more porous polypropylene films made using thermally induced phase separation (“TIPS”), described in U.S. Pat. No. 5,976,686 (Kaytor et al.).

The back reflector 114 can be substantially flat and smooth, or it may have a structured surface associated with it to enhance light scattering or mixing. Such a structured surface can be imparted (a) on the surface of the back reflector 114, or (b) on a transparent coating applied to the surface. In the former case, a highly reflecting film may be laminated to a substrate in which a structured surface was previously formed, or a highly reflecting film may be laminated to a flat substrate (such as a thin metal sheet, as with Vikuiti™ Durable Enhanced Specular Reflector-Metal (DESR-M) reflector available from 3M Company) followed by forming the structured surface, such as with a stamping operation. In the latter case, a transparent film having a structured surface can be laminated to a flat reflective surface, or a transparent film can be applied to the reflector and then afterwards a structured surface can be imparted to the top of the transparent film.

For those embodiments that include a direct-lit configuration, i.e., a configuration in which one or more light sources are disposed directly behind the output or emitting area of the lighting system 110, the back reflector can be a continuous unitary and unbroken layer on which the light source(s) are mounted, or it can be constructed discontinuously in separate pieces, or discontinuously insofar as it includes isolated apertures, through which light sources can protrude, in an otherwise continuous layer. For example, strips of reflective material can be applied to a substrate on which rows of light sources are mounted, each strip having a width sufficient to extend from one row of light sources to another and having a length dimension sufficient to span between opposed borders of the backlight's output area.

Lighting system 110 also includes one or more light sources, not shown in the view of FIG. 1, that are disposed to emit light into the recycling cavity. The light sources preferably emit light over the extended wavelength band of interest, typically, the visible spectrum. Cold cathode fluorescent lamps (CCFLs), for example, provide white light emission over their long narrow emissive areas, and those emissive areas can also operate to scatter some light impinging on the CCFL, such as would occur in a recycling cavity. The typical emission from a CCFL has an angular distribution that is substantially Lambertian, which may be inefficient or otherwise undesirable in some ultra low loss backlight designs. Also, the emissive surface of a CCFL, although somewhat diffusely reflective, also typically has an absorptive loss that may be excessive in such applications. On the other hand, CCFL sources are perfectly adequate in higher loss systems such as overhead luminaires or task lighting.

Light emitting diodes (LEDs) are also suitable for use as the light source(s). An LED die emits light in a near-Lambertian manner, but because of its much smaller size relative to CCFLs, the LED light distribution can be readily modified, e.g., with an integral encapsulant lens, reflector, or extractor to make the resulting packaged LED a forward-emitter, a side-emitter, or other non-Lambertian profile, which may be beneficial in some applications. However, the smaller size and higher intensity of LED sources relative to CCFLs can also make it more difficult to produce a spatially uniform backlight output using LEDs. This is particularly true in cases where individually colored LEDs, such as arrangements of red/green/blue (RGB) LEDs, are used to produce white light, since failure to provide adequate lateral transport or mixing of such light can result in undesirable colored bands or areas. White light emitting LEDs, in which a phosphor is excited by a blue or UV-emitting LED die to produce intense white light from a small area or volume on the order of an LED die, can be used to reduce such color non-uniformity. But white LEDs currently are unable to provide LCD color gamuts as wide as those achievable with individual colored LED arrangements and thus may not be desirable for all end-use applications.

Whichever light sources are used, they may be positioned directly behind the extended output surface of the system 110, i.e., directly behind the multilayer optical film 112, or may be positioned along the edge of the output surface. The former case is referred to as a “direct-lit” system, and the latter is an “edge-lit” system. In some cases, a direct-lit system may also include one or some light sources at the periphery of the device, or an edge-lit system may include one or some light sources directly behind the output area. In such cases, the system can be considered to be “direct-lit” if most of the light originates from directly behind the output area, and “edge-lit” if most of the light originates from the periphery of the output area. Direct-lit systems are susceptible to the phenomenon of “punchthrough”, where a bright spot appears in the output area above each source. Edge-lit systems typically include a solid light guide that carries or guides light from the edge-mounted light source to all portions of the output area, the light guide also having light extraction features to direct light out of the light guide towards a viewer 130. If the system 110 is a backlight for a liquid crystal display (LCD) device, then additional components would typically be included between the film 112 and the viewer 130, such as one or more polarizers (including absorbing polarizers and reflecting polarizers), diffusers, prismatic films (including any of the Brightness Enhancement Films (BEF) available from 3M Company and including available turning films), and a liquid crystal panel. If the system is simpler, such as an overhead luminaire or a task light, then additional components may include a diffuser film or panel, and/or other rigid light-transmissive panel to which the disclosed multilayer optical film may be laminated or against which the disclosed multilayer optical film may be placed.

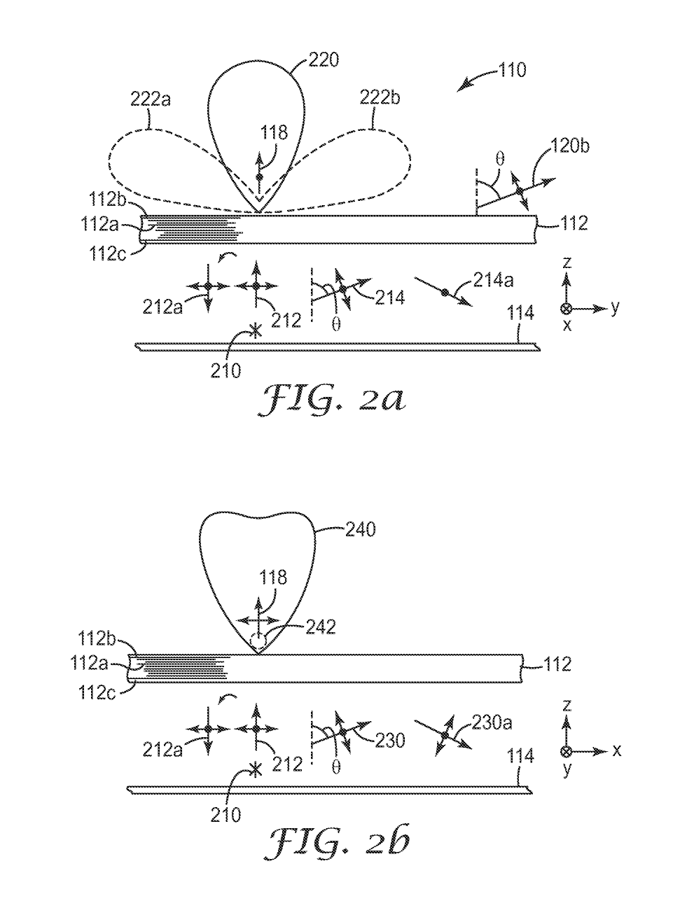

Turning again to FIG. 1, observers 132 and 134 are also shown for reference purposes to further demonstrate the fundamental optical characteristics of the multilayer optical film 112. Observer 132 looks along the pass axis 122, and sees lighting system 110 as shown in the partial schematic side view of FIG. 2a. Observer 134 looks along the block axis 124, and sees lighting system 110 as shown in the partial schematic side view of FIG. 2b.

In FIG. 2a, a generic light source 210 is shown disposed between film 112 and back reflector 114 in a direct-lit configuration, directly behind the output surface of the lighting system. The light source 210 is shown to emit two unpolarized light rays: normally incident ray 212, and obliquely incident ray 214 which lies in the y-z (block) plane and subtends a polar angle θ relative to the surface normal or z-axis. These rays impinge upon the rear major surface of multilayer optical film 112, which film is now depicted with some of its constituent components including a stack of microlayers 112a and (optional) optically thick outer skin layers 112b, 112c, which are not intended to be drawn to scale. These constituent components are shown for convenience over only a portion of the film 112 but will be understood to extend across the entire length and width of the film 112. With appropriate design of the film 112, the film separates the orthogonal polarization components of the unpolarized light ray 212 by strongly transmitting the portion of the light polarized parallel to the pass axis 122 (or x-axis), and strongly reflecting the portion of the light polarized parallel to the block axis 124 (or y-axis). The transmitted portion becomes ray 118, which was seen in FIG. 1. The reflected portion is reflected back towards the back reflector 114 as ray 212a. The film 112 is also tailored to separate light polarized in the y-z or block plane according to the direction of incidence, in that such light impinging normally on the film is strongly reflected (see rays 212, 212a), but such light impinging at a highly oblique polar angle θ (see the portion of ray 214 polarized in the plane of the drawing) is strongly transmitted as ray 120b, seen earlier in FIG. 1. The portion of oblique ray 214 polarized along the x- or pass axis 122 is shown to be partially transmitted (ray 120b) and partially reflected (ray 214a), with the portion transmitted decreasing (and the portion reflected increasing) as the angle θ increases, as a result of reflections at the film/air interface(s). Note also that a small amount of the polarization state in the y-z plane from ray 212 will be included in transmitted ray 118.

Polar angle flux envelopes 220, 222 (labeled by its separate halves or lobes 222a, 222b) are provided in FIG. 2a to depict qualitatively the angular dependence of the transmission of the film 112 for the two orthogonal polarization states, for light incident in the y-z or block plane. These envelopes can be considered to represent the flux or brightness of light transmitted by the film 112, or alternatively the percent transmission of the film 112, as a function of polar angle θ for light of a specified polarization in the specified plane of incidence. Envelope 220 shows that the component of such light polarized along the x-axis or pass axis 122, i.e., s-polarized light, experiences maximum transmission at normal incidence and decreasing transmission for increasing angle of incidence θ. Envelope 222 shows that the component of such light polarized in the plane of incidence, i.e., p-polarized light, has a small or negligible transmission at normal incidence which increases to a maximum at a large oblique angle θoblique. If the reflectivity values include the effects of one or two film/air surface reflections, the transmission of the p-polarized light will typically rapidly decline between the angle θoblique and grazing incidence (θ=90 degrees), as shown by envelopes 222a, b.

FIG. 2b is similar to FIG. 2a but for the observer 134 who looks along the y-axis or block axis 124. This observer also sees the light source 210 emitting normally incident ray 212, which is strongly transmitted for light polarized along the pass axis 122 or x-axis to produce ray 118, and strongly reflected for the orthogonal polarization to produce ray 212a as described previously. Source 210 also emits another oblique ray 230, which subtends an angle θ relative to the surface normal or z-axis like ray 214 of FIG. 2a, but unlike that ray is disposed in the orthogonal x-z plane. In this plane of incidence, one polarization state of the ray 230 is strongly reflected at all angles, and the orthogonal polarization state is strongly transmitted at normal incidence but for large incidence angles it is increasingly reflected at the film/air interfaces. The strong reflection of both polarization states at very large incidence angles is depicted by reflected ray 230a. Polar flux envelopes 240, 242 depict qualitatively the angular dependence of the transmission of the film 112 for the two orthogonal polarization states, for light incident in the x-z or pass plane. Envelope 240 shows that the component of such light polarized in the plane of incidence, i.e., p-polarized light, experiences maximum transmission at normal or near-normal incidence and decreasing transmission for increasing angles of incidence θ. (Note that the small increase in transmission at relatively small angles of incidence, resulting in a slight heart-shaped envelope 240, results from including the effects of one or two film/air interfaces in the transmission values and from a Brewster-related reflection minimum for the p-polarized light.) Envelope 242 shows that the component of such light polarized along the block axis 124 or y-axis, i.e., s-polarized light, has a very small transmission at normal incidence which decreases even more with increasing incidence angle.

Of course, it should be understood that light source 210 may emit light in all directions, such as with a CCFL light source, or over a hemisphere of solid angle e.g. for an LED mounted on the back reflector 114, or over a limited set of angles within the hemisphere e.g. for certain “side-emitting” packaged LEDs. It should also be understood that, to the extent film 112 is illuminated so that it transmits light over its entire surface area, the flux envelopes can be considered to be representative of light emitted over all, or over any arbitrary portion, of the surface area of the film.

We now turn to a more detailed description of the reflective multilayer optical film 112, and explain how it can be designed to exhibit the foregoing reflection and transmission properties.

As stated above, multilayer optical films include individual microlayers having different refractive index characteristics so that some light is reflected at interfaces between adjacent microlayers. The microlayers are sufficiently thin so that light reflected at a plurality of the interfaces undergoes constructive or destructive interference to give the multilayer optical film the desired reflective or transmissive properties. For multilayer optical films designed to reflect light at ultraviolet, visible, or near-infrared wavelengths, each microlayer generally has an optical thickness (a physical thickness multiplied by refractive index) of less than about 1 μm. However, thicker layers can also be included, such as skin layers at the outer surfaces of the multilayer optical film, or protective boundary layers (PBLs) disposed within the multilayer optical film to separate coherent groupings (known as “stacks” or “packets”) of microlayers. If desired, two or more separate multilayer optical films can be laminated together with one or more thick adhesive layers to form a laminate.

In a simple embodiment, the microlayers can have thicknesses and refractive index values corresponding to a ¼-wave stack, i.e., arranged in optical repeat units or unit cells each having two adjacent microlayers of equal optical thickness (f-ratio=50%), such optical repeat unit being effective to reflect by constructive interference light whose wavelength λ is twice the overall optical thickness of the optical repeat unit, where the “optical thickness” of a body refers to its physical thickness multiplied by its refractive index. Thickness gradients along the thickness axis of the film (z-axis) are used to provide a widened reflection band to provide substantially spectrally flat transmission and reflection of light over the extended wavelength band of interest, and also over all angles of interest. Thickness gradients tailored to sharpen the band edges at the wavelength transition between high reflection and high transmission can also be used, as discussed in U.S. Pat. No. 6,157,490 (Wheatley et al.). For polymeric multilayer optical films, reflection bands can be designed to have sharpened band edges as well as “flat top” reflection bands, in which the reflection properties are essentially constant across the wavelength range of application. A spectrally flat, wide reflection band is of particular significance to the multilayer optical films described herein. Other layer arrangements, such as multilayer optical films having 2-microlayer optical repeat units whose f-ratio is different from 50%, or films whose optical repeat units include more than two microlayers, are also contemplated. These alternative optical repeat unit designs can be configured to reduce or to excite certain higher-order reflections, which may be useful if the desired extended wavelength band extends to near infrared wavelengths. See, e.g., U.S. Pat. Nos. 5,360,659 (Arends et al.) and 5,103,337 (Schrenk et al.).

Further details of suitable multilayer optical films and related designs and constructions can be found in U.S. Pat. No. 5,882,774 (Jonza et al.), 6,531,230 (Weber et al.), PCT Publication Nos. WO 95/17303 (Ouderkirk et al.), WO 99/39224 (Ouderkirk et al.), and “Giant Birefringent Optics in Multilayer Polymer Mirrors”, Science, Vol. 287, March 2000 (Weber et al.).

Multilayer optical films and film bodies can include additional layers and coatings selected for their optical, mechanical, and/or chemical properties. For example, a UV absorbing layer can be added at the incident side of the optical element to protect components from degradation caused by UV light. Additional layers and coatings can also include scratch resistant layers, tear resistant layers, and stiffening agents. See, e.g., U.S. Pat. No. 6,368,699 (Gilbert et al.).

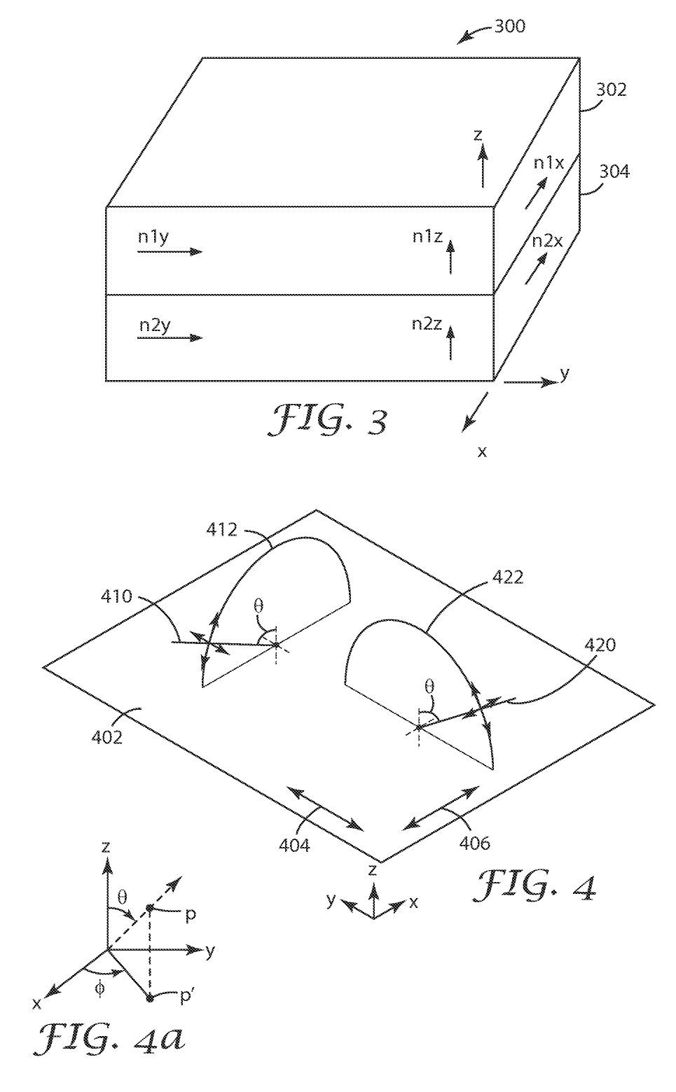

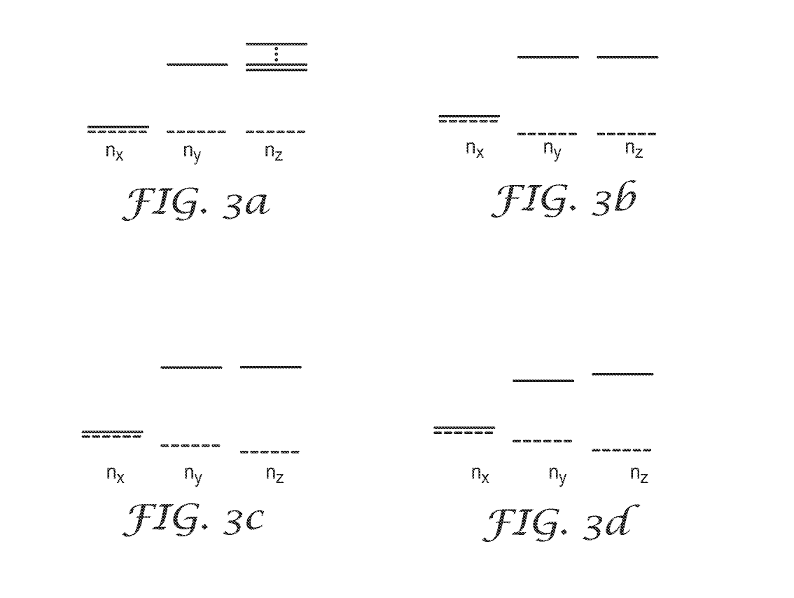

FIG. 3 depicts two adjacent microlayers 302, 304, constituting one optical repeat unit, of a multilayer optical film 300. The film 300 typically includes tens, hundreds, or thousands of such microlayers, as well as optional skin layers and protective boundary layers as described above, none of which are shown in the figure except for the single pair of microlayers. The microlayers are sufficiently thin so that light reflected at a plurality of the interfaces undergoes constructive or destructive interference to give the film the described reflective and transmissive properties. Each microlayer can be characterized, at least in localized positions in the film, by in-plane refractive indices nₓ, n_{y}, and a refractive index n_{z} associated with a thickness or z-axis of the film. These indices represent the refractive index of the subject material for light polarized along the mutually orthogonal x-, y-, and z-axes, respectively. The reflective and transmissive properties of the multilayer optical film 300 are a function of these refractive indices of the respective microlayers. Of particular significance is the refractive index difference between adjacent microlayers for light polarized along the x-axis (Δnₓ), the y-axis (Δn_{y}), and the z-axis (Δn_{z}). Another significant design parameter is the total number of microlayers used, and the layer thickness distribution of the microlayers along the z-axis of the film.

We have found the following design guidelines to be useful to help achieve the desired reflectivity and transmission characteristics of the multilayer optical film as described above. Generally, the combination of a very small index difference (including but not limited to an index difference of exactly zero) along one in-plane axis and a much larger index difference along an orthogonal in-plane axis is desirable in order to adequately separate the two orthogonal polarization states for normally incident light. Given these in-plane index differences, the total number of microlayers can then be chosen to be large enough to provide a high reflectivity for normally incident light polarized along the large mismatch direction, but small enough to maintain a low reflectivity and high transmission for the orthogonal polarization, in the event that the very small in-plane index difference is nonzero. Note that assigning labels to the respective in-plane axes is arbitrary, and any convention can be used, but we tend to refer to the in-plane axis associated with the largest magnitude refractive index difference as the y-axis, and the orthogonal in-plane axis, which is typically associated with the smallest magnitude refractive index difference, as the x-axis. (We do this to follow the convention of referring to a primary stretch direction of a multilayer optical film as the x-axis, combined with our preference described further below for using a negatively birefringent polymer material for at least one of the microlayers in each optical repeat unit, such that stretching the material under appropriate conditions along the x-axis reduces the refractive index along that direction.) In such a case, Δn_{y} refers to the largest magnitude refractive index difference in the plane of the film between adjacent microlayers, and Δnₓ refers to typically the smallest such in-plane refractive index difference.

We now turn our attention to the refractive index difference along the thickness or z-axis of the film, Δn_{z}. Contrary to much of the emphasis of prior work on multilayer optical films dealing with Δn_{z}, we select for purposes of the present multilayer optical films a Δn_{z} that is as large as possible, preferably on the order of the largest in-plane refractive index difference Δn_{y} and more preferably even larger, provided that the sign or polarity of Δn_{z} is the same as that of Δn_{z}. In this regard, two refractive index differences Δn_{y}, Δn_{z} have the same polarity or sign if the microlayer that has the higher refractive index n_{z} in the z-direction also has the higher refractive index n_{y} along the y-direction, and vice versa: the microlayer having the lower refractive index n_{z} in the z-direction also has the lower refractive index n_{y} in the y-direction. By selecting an out-of-plane index difference Δn_{z} on the order of or larger than Δn_{y}, we ensure the film has at least one internal Brewster angle, and in some cases a Brewster angle that is accessible from air with flat film surfaces, and we allow the Brewster angle effects to be strong enough to greatly reduce the off-axis reflectivity of p-polarized light incident on the film from an air medium and in the y-z plane.

A Brewster angle is the angle of incidence at which the reflectance of light incident on a plane boundary between two regions having different refractive indices is zero for such light that has its electrical field vector in the plane defined by the direction of propagation and the normal to the surface. In other words, for light incident on a plane boundary between two regions having different refractive indices, a Brewster angle is the angle of incidence at which the reflectance is zero for p-polarized light. For propagation from a first isotropic medium of refractive index n₁ to a second isotropic medium of refractive index n₂, Brewster's angle is given as arc tan (n₂/n₁). By “internal Brewster angle”, we refer to a Brewster angle at an interface that is internal to the film and not at an interface with air or other components in the system, whether or nor it is possible to inject light from an external air medium into the film such that it propagates at the internal Brewster angle. An internal Brewster angle can be present in an optical structure when there is an interface within the structure between adjacent portions having two different indices of refraction. A given multilayer optical film may or may not have an internal Brewster angle. For example, if one or both of the alternating layers in a multilayer optical mirror film are birefringent, and the z-indices of refraction of the layers have a certain differential, Δn_{z}, relative to the in-plane indices, then no internal Brewster angle will exist. However, the refractive indices may be alternatively selected to provide a different Δn_{z} that, in concert with the in-plane index difference, produces an internal Brewster angle. Note that a given interface may possess two, one, or zero internal Brewster angles: a first internal Brewster angle for light incident in the x-z plane, and a second internal Brewster angle for light incident in the y-z plane; an internal Brewster angle for light in only one of the x-z plane or the y-z plane; or no internal Brewster angle in either the x-z plane or the y-z plane.

FIGS. 3a-d depict exemplary refractive index relationships that satisfy the guidelines discussed above and that are achievable with existing coextrudable polymer materials and known processing equipment through judicious materials selection and processing conditions. In these figures, the relative refractive indices of two materials, corresponding to the two adjacent microlayers in a multilayer optical film, are shown in three columns corresponding to the refractive index of each material in the x-, y-, and z-direction, where solid bars are used for one material and broken-line bars are used for the other material. The vertical axis in each of the figures is not labeled, but corresponds to refractive index with a higher bar corresponding to a higher refractive index. Of course, the refractive index difference for a given axis can be readily determined by comparing the level of the solid bar to the level of the broken bar for the appropriate column.

FIG. 3a represents the refractive indices for a layer pair in which the higher refractive index material is negatively birefringent and the lower refractive index material is isotropic. In this figure, the z-index of the birefringent material is shown as a sequence of solid bars to demonstrate that Δn_{z} can be on the order of Δn_{y} or greater, and of the same sign. Stretching of the negatively birefringent material under appropriate conditions causes its refractive index nₓ in the x-direction to decrease and its refractive indices in the y- and z-directions, n_{y} and n_{z}, to increase.

Combinations of a negative birefringent material and a positive birefringent material can also be used, to enhance the performance of the multilayer optical film. In particular, if both polymers of the layer pair exhibit permanent birefringence after stretching and of the opposite sign, then the normal incidence reflection can be increased and the Brewster angle can be decreased for the block axis compared to a film that uses only one of the birefringent polymers with an isotropic polymer. There are multiple orientation strategies to affect these enhancements. FIGS. 3b-d illustrate the relative changes in the x, y, and z indices for both polymers as a function of the orientation condition. The orientation can be applied via either a true uniaxial stretch (FIG. 3b), a constrained uniaxial stretch (FIG. 3c), or an asymmetrical biaxial stretch (FIG. 3d). The refractive index relationships illustrated in FIGS. 3b-d can be achieved with syndiotactic polystyrene (sPS) as the high refractive index, negatively birefringent material, and polypropylene as the low refractive index, positively birefringent material.

With a true uniaxial stretch, which allows full relaxation in the non-stretch direction, Δny=Δnz With this construction, the reflectivity for light incident in the y-z (block) plane behaves the same as for an isotropic reflector that has a Brewster angle beyond 90 degrees in air, i.e., an internal Brewster angle not accessible from air. With other stretch conditions, the Brewster angle can be reduced to the point where it occurs at less than 90 degrees in air, i.e., it becomes an internal Brewster angle that is accessible from air.

The largest z-index difference Δn_{y}, relative to Δn_{y}, occurs for an asymmetric biaxial stretch, although care should be taken to keep Δnₓ relatively small. One may wish to use a different low index material if nₓ of the sPS increases substantially. The asymmetrical biaxial stretch provides the smallest Brewster angle, but reduces Δn_{y} compared to a true uniaxial stretch, thus requiring more layers to provide an equally high block-axis reflectivity at normal incidence. A constrained uniaxial orientation, as in a standard film tenter, will provide an intermediate condition between the true uniaxial stretch and an asymmetrical biaxial stretch.

Suitable multilayer optical films can be fabricated with a positive birefringent material for one microlayer and an isotropic material for the other microlayer, i.e., with no negative birefringent material layer in the optical repeat units of the multilayer optical film, if the high refractive index (stretch axis index) of the positive birefringent polymer is matched with a high index isotropic polymer. Alternatively, if both a positive and negative birefringent material are used, the high refractive index of the positive birefringent polymer can be matched to the low index of the negatively birefringent polymer.

A variety of polymer materials are currently available from which one can select pairs of materials that are coextrudable and otherwise processable with known coextrusion and tentering equipment to produce the described multilayer optical films, and that can achieve the desired refractive index relationships discussed above. Additional suitable materials will likely become available in the future as well. An exemplary negatively birefringent material currently available is syndiotactic polystyrene (sPS). Suitable low refractive index isotropic materials include: Neostar Elastomer FN007, a copolyester available from Eastman Chemical Company, Kingsport, Tenn.; Kraton G1657, a styrene ethylene/butadiene styrene block copolymer available from Kraton Polymers; polyethylene; copolymers of polypropylene and polyethylene; polymethyl methacrylate (“PMMA”); copolymers of PMMA (“coPMMA”); polyvinyl butyral (“PVB”); polyvinyl alcohol (“PVA”); ethylene/octene copolymers; THV™ fluoropolymer available from 3M Company, St. Paul, Minn.; and a Silicone Poly-oxamide (SPOx), or more precisely a “polydiorganosiloxane polyoxamide block copolymer” as described in commonly assigned U.S. Patent Application Publication US 2007/0177272 (Benson et al.), “Multilayer Films Including Thermoplastic Silicone Block Copolymers” (Attorney Docket No. 61494US007).

The control of color in the reflective multilayer optical films can be important when the transmitted light is viewed directly as in a backlit display, or when transmitted light is used for purposes of viewing other objects as in general illumination. This usage is in contrast to typical mirrors which are viewed in reflection, i.e., when only reflected light is viewed. For partial reflectors having low transmission, small variations in transmission at different wavelengths, such as e.g. a mirror having 5% transmission at some wavelengths and 10% transmission at other wavelengths, can produce a rather colorful film. The color is controlled by the shape of the reflectance spectrum. Known processes, such as vacuum deposition, can precisely control the layer thickness value of each individual layer in the layer stack to control the color of mirrors having intermediate reflectance. However, individual layer control is more difficult using polymer coextrusion techniques with hundreds of individual polymer layers.

U.S. Pat. Nos. 5,126,880 (Wheatley et al.) and 5,568,316 (Schrenk et al.) teach the use of combinations of thin and very thick layers to reduce the iridescence of multilayer interference reflectors. If a high reflectivity is desired at some angle, e.g. at normal incidence, then a large number of layers is required with this approach, and this results in a very thick film which increases the light losses in the film.

A preferred approach is to use all or mostly quarter-wave film stacks. In this case, control of the spectrum requires control of the layer thickness profile in the film stack. A broadband spectrum, such as one required to reflect visible light over a large range of angles in air, still requires a large number of layers if the layers are polymeric, due to the relatively small index differences achievable with polymer films compared to inorganic films. Layer thickness profiles of such films can be adjusted to provide for improved spectral characteristics using the axial rod apparatus taught in U.S. Pat. No. 6,783,349 (Neavin et al.) combined with layer profile information obtained with microscopic techniques.

Polymeric multilayer optical films with high layer counts (greater than about 250 layers) have traditionally been made using a layer multiplier, i.e. they have been constructed of multiple packets of layers which were generated from a single set of slot generated layers in a feedblock. This method is outlined in U.S. Pat. No. 6,783,349 (Neavin et al.). Although such layer multiplier devices greatly simplify the generation of a large number of optical layers, the distortions they impart to each resultant packet of layers are not identical for each packet. For this reason, any adjustment in the layer thickness profile of the layers generated in the feedblock is not the same for each packet, meaning that all packets cannot be simultaneously optimized to produce a uniform smooth spectrum free of spectral disruptions. Thus, an optimum profile and low transmission color reflector is difficult to make with multipacket films using multipliers. If the number of layers in a single packet generated directly in a feedblock do not provide sufficient reflectivity, then two or more such films can be laminated to increase the reflectivity, although this will in general increase the losses in the mirror.

A desirable technique for providing a multilayer optical film with a low color, or a controlled color spectrum, is therefore as follows:
1) The use of an axial rod heater control of the layer thickness values of coextruded polymer layers as taught in U.S. Pat. No. 6,783,349 (Neavin et al.).
2) A feedblock design such that all layers in the stack are directly controlled by an axial rod heater zone during layer formation, i.e. no use of layer multipliers.
3) Timely layer thickness profile feedback during production from a layer thickness measurement tool such as e.g. an atomic force microscope (AFM), a transmission electron microscope, or a scanning electron microscope.
4) Optical modeling to generate the desired layer thickness profile.
5) Repeating axial rod adjustments based on the difference between the measured layer profile and the desired layer profile.
   Although not as accurate in general as an AFM, the layer profile can also be quickly estimated by integrating the optical spectrum (integrating the −Log(1−R) vs. wavelength spectrum). This follows from the general principle that the spectral shape of a reflector can be obtained from the derivative of the layer thickness profile, provided the layer thickness profile is monotonically increasing or decreasing with respect to layer number.

The basic process for layer thickness profile control involves adjustment of axial rod zone power settings based on the difference of the target layer thickness profile and the measured layer profile. The axial rod power increase needed to adjust the layer thickness values in a given feedblock zone may first be calibrated in terms of watts of heat input per nanometer of resulting thickness change of the layers generated in that heater zone. Fine control of the spectrum is possible using 24 axial rod zones for 275 layers. Once calibrated, the necessary power adjustments can be calculated once given a target profile and a measured profile. The procedure is repeated until the two profiles converge.

We turn now to FIGS. 4 and 4a to address certain geometrical considerations and conventions when discussing the various angles and directions of incident and reflected light with respect to a film or body. FIG. 4 investigates the behavior of light incident on an “ideal” polarizing film, to make the point that one must specify the incidence direction of s- and p-polarized light before one can draw conclusions about its transmission or reflection by the film. A light ray 410 is incident on an ideal polarizing film 402 at an angle of incidence θ, thereby forming a plane of incidence 412. The film 402 includes a pass axis 406 that is parallel to the x-axis, and a block axis 404 that is parallel to the y-axis. The plane of incidence 422 of ray 420 is parallel to the block axis 404. Ray 420 has a p-polarized component that is in the plane of incidence 422, and an s-polarized component that is orthogonal to the plane of incidence 422. The p-pol light of ray 420 is at least partially parallel to the block axis 404 of polarizer 402 and may therefore, depending on the incidence angle, be reflected by the polarizer, while the s-pol light of ray 420 is parallel to the pass axis 406 of polarizer 402 and, at least in part, be transmitted.

Further, FIG. 4 illustrates ray 410 that is incident on polarizer 402 in a plane of incidence 412 that is parallel to the pass axis 406 of the polarizer 402. Therefore, the p-pol light of ray 410 is parallel to the pass axis 406 of the polarizer 402, while the s-pol light of ray 410 is parallel to the block axis 404 of polarizer 402. As a result, if the polarizer 402 is an “ideal” polarizer that has a reflectance of 100% at all angles of incident light for light polarized in the block axis and 0% at all angles of incident light for light polarized in the pass axis, the polarizer transmits s-pol light of ray 420 and the p-pol light of ray 410, while reflecting the p-pol light of ray 420 and the s-pol light of ray 410. In other words, the polarizer 402 will transmit a combination of p- and s-pol light.

FIG. 4a shows an arbitrary direction vector passing through the origin of the x-y-z coordinate system and also passing through a point p. The point p has a projection p′ in the x-y plane. The direction vector, which may correspond to a direction of incidence, reflection, or transmission, subtends a polar angle θ with respect to the z-axis. The projection of the vector in the x-y plane makes an azimuthal angle φ with respect to the x-axis, or with respect to some other designated axis in the x-y plane. The direction vector can thus be characterized uniquely by the angle pair θ, φ, where θ ranges from 0 to 90 degrees and φ ranges from 0 to 360 degrees, or from −180 to +180 degrees, for example. Note also that a plane of incidence for light incident on a film disposed in the x-y plane can be specified by the azimuthal angle φ, with the x-z plane being specified by φ=0 or 180 degrees and the y-z plane being specified by φ=90 or −90 or 270 degrees.

We describe now some particular multilayer optical film embodiments suitable for use as high transmission flux leveling films with the desired reflection and transmission characteristics discussed above.

In a first case, we select sPS for one of the polymers in the alternating stack and a copolyester polymer known commercially as Neostar Elastomer FN007 available from Eastman Chemical Company, Kingsport, Tenn., as the other polymer. These polymers are compatible for coextrusion and exhibit acceptable inter-layer adhesion when stretched. An extrudate of alternating layers of these materials can be oriented under suitable conditions to provide a multilayer optical film having the following refractive indices:

| | nₓ | n_{y} | n_{z} |
|---|---|---|---|
| sPS microlayers | 1.510 | 1.620 | 1.620 |
| FN007 microlayers | 1.506 | 1.506 | 1.506 |
| Skin 1 | 1.506 | 1.506 | 1.506 |
| Skin 2 | 1.506 | 1.506 | 1.506 |
| External | 1.0 | 1.0 | 1.0 |

These indices provide each microlayer interface with two internal Brewster angles, one in the x-z plane and one in the y-z plane. This embodiment assumes 550 individual microlayers arranged in a single stack or packet with no intervening protective boundary layers, half of the microlayers being composed of sPS and the other half of the FN007 polymer, in an alternating arrangement. The stack thus consists essentially of 275 optical repeat units, each repeat unit containing one microlayer of sPS and one microlayer of FN007. The stack also incorporates a monotonic layer thickness gradient across the thickness direction of the film, with the thinnest optical repeat unit, at one end of the stack, having an optical thickness of 200 nm, and the thickest optical repeat unit, at the opposite end of the stack, having an optical thickness of 450 nm. This layer distribution provides a substantially flat, wide reflection band extending from 400 nm to 900 nm. Finally, this embodiment includes optically thick skin layers on opposite sides of the stack, the skin layers having isotropic refractive indices as shown in the table above and being representative of the FN007 polymer. Each skin layer contacts the microlayer stack on one side and air (“External” in the table above) on the other side.

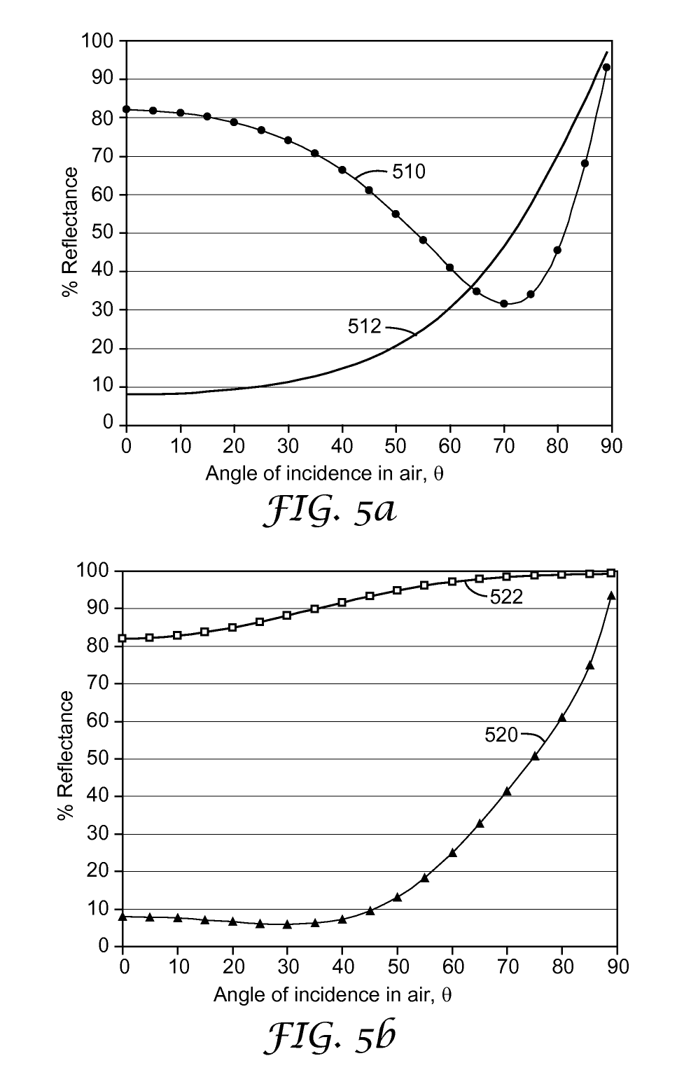

This embodiment was modeled with the aid of a computer and its reflectivity calculated as a function of direction of incidence in air and polarization, assuming the reflection band extends from 400 to 900 nm at normal incidence. The results so obtained, and including the effects of the two film/air interfaces at the outer surfaces of the skin layers, are shown in FIGS. 5a and 5b.

FIG. 5a shows the results for light incident in the block (y-z) plane. For this plane, p-polarized light (curve 510) at near-normal incidence (θ≈0) is substantially parallel to the block or y-axis of the film and is thus strongly reflected by the large y-index difference Δn_{y}. S-polarized light (curve 512) at near-normal incidence, on the other hand, is substantially parallel to the pass or x-axis of the film and is thus weakly reflected and strongly transmitted, recalling that reflectivity+transmission≈100%. The low reflectivity of about 10% for this light at near-normal incidence is predominantly due to the film/air surface reflections, which then increases monotonically with increasing incidence angle from θ=0 to θ=90 degrees. In contrast, curve 510 decreases to a minimum at an angle θoblique of about 70 degrees, corresponding to a transmission maximum for p-polarized light at that angle, as the angle of incidence increases from normal.

FIG. 5b shows the results for light incident in the pass (x-z) plane. For this plane of incidence, p-polarized light (curve 520) at near-normal incidence is substantially parallel to the pass or x-axis of the film and is thus strongly transmitted and weakly reflected. Except for a slight decrease in reflectivity from θ=0 to about 30 degrees due to Brewster angle effects of the surface reflections, curve 520 experiences a strong increase in reflectivity with increasing incidence angle due to film/air surface reflections, which become substantial for angles θ beyond about 75 degrees. S-polarized light (curve 522) at near-normal incidence is substantially parallel to the block or y-axis of the film and is thus strongly reflected. This curve monotonically increases still more as θ increases from 0 to 90 degrees.

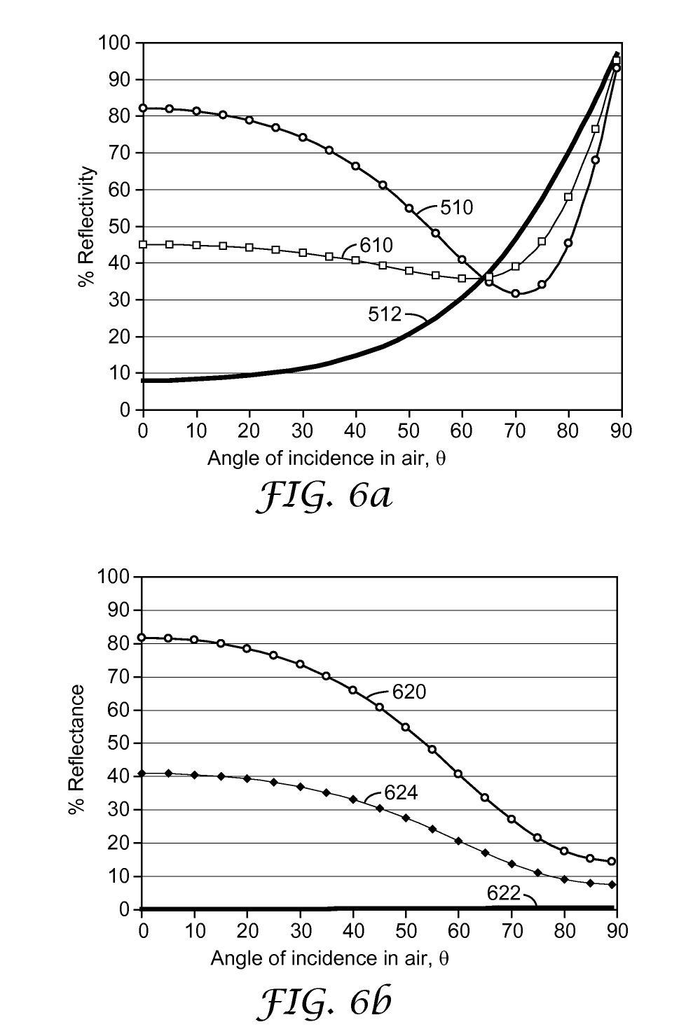

One can see by inspection of curves 520, 522 that the reflectivity for unpolarized light (i.e. the average of curves 520, 522) incident in the pass (x-z) plane greatly increases from normal incidence to oblique angles, and transmission correspondingly decreases. However, curves 510, 512 must be analyzed more carefully to determine the effect of incidence angle on reflectivity and transmission of unpolarized light in the block (y-z) plane. In fact, as confirmed by the graphs of FIGS. 6a and 6b, the multilayer film has been designed so that the decrease in reflectivity of curve 510 overcomes the increase in reflectivity of curve 512, so that—even when the effects of two film/air interfaces are included in the reflectivity values—the net reflectivity for unpolarized light at θ=θoblique is less than it is at normal incidence, and the transmission is greater. In FIG. 6a, curves 510 and 512 are substantially reproduced from FIG. 5a, and the average thereof produces curve 610 which is representative of unpolarized light. Curve 610 is lower at an oblique angle θoblique of about 60 degrees than at normal incidence.

FIG. 6b is a graph similar to FIG. 6a, but where the effects of the two film/air surface reflections have been removed from the reflectivity values. Thus, curve 620 is the reflectivity of p-polarized light incident in the block plane, curve 622 is the reflectivity of s-polarized light incident in the block plane, and curve 624 is the average thereof representative of unpolarized light. Using these values, curve 624 is seen to be substantially lower over a wide range of oblique angles θ, e.g., at least from 60 to 90 degrees, relative to normal incidence.

Inspection and consideration of the average (unpolarized) reflectivity curve 624 reveals, however, a practical limitation of the disclosed high transmission flux leveling films in dealing with flux leveling of light intensity in lighting systems. In particular, for films of this type, the maximum average reflectivity for unpolarized light at normal incidence is only about 50% because light polarized along the pass axis accounts for half of the unpolarized light, yet the pass axis reflects little or none of that light. Consequently, the minimum average transmission for normally incident unpolarized light is also on the order of 50% (hence the term “high transmission” flux leveling film), and thus the maximum achievable variation in transmission from normal to oblique incidence is only roughly a 2:1 ratio (100% to 50%). This practical limit restricts the degree of uniformity one can expect to achieve with such films. However, the relatively low average reflectivity of the films produces less light recycling, a feature that is generally more valuable in fluorescent bulb-lit systems than LED lit systems due to the typically higher losses in the former systems. The disclosed films may therefore find greater application in general lighting systems such as luminaires rather than in LCD backlight systems for displays because the former generally have more relaxed uniformity requirements than the latter. Nevertheless, the disclosed films may also be used in backlights.

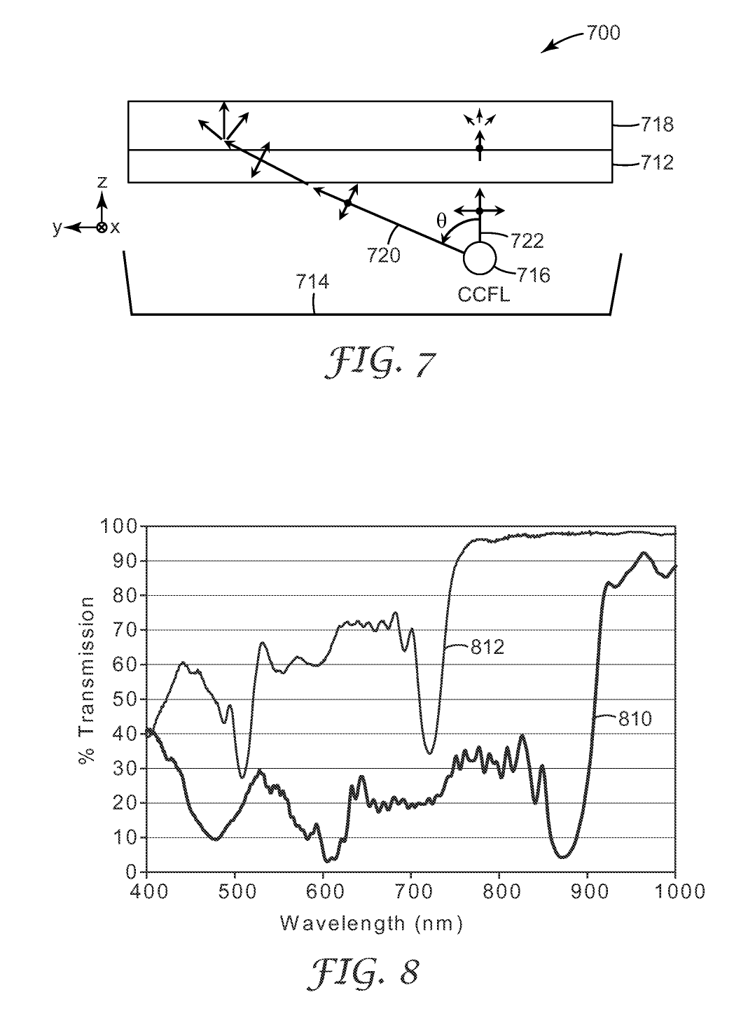

FIG. 7 shows a schematic side view of another direct-lit lighting system 700, which may be suitable as a backlight. The system uses a reflective multilayer optical film 712 configured as a high transmission flux leveling film, with a block axis oriented in the y-direction. The system 700 also includes a back reflector 714, light source 716, and diffuser plate 718 arranged as shown. By laminating the film 712 to the major surface of the diffuser plate, which would otherwise be exposed to air, no additional air/polymer surface reflections are introduced to the system, so the net change to the system provided by the film 712 is essentially the internal reflectivity of the film, i.e., the reflectivity or transmission of the film without taking into account the effects of any film/air interfaces.

The film 712 can be used to supply light to the diffuser plate 718 with a more uniform spatial distribution than can be attained without the film. For a linear light source 716, the intensity of light emitted by the source and striking the surface of an adjacent planar diffuser decreases as 1/distance squared from the source. The film 712 in conjunction with a diffuse or semi-diffuse back reflector 714 can help modify this distribution when applied as shown in FIG. 7. Due to the strong off-axis Brewster angle effects, the film 712 has a higher transmission coefficient for oblique light ray 720 emitted at a large angle θ than for ray 722 emitted perpendicular to the film surface, where the transmission coefficient refers to the average transmission for both polarization states of a given ray.

Although the variation of transmission of the film with distance from the source is not the exact inverse of the 1/r² relationship of bulb intensity with distance, the recycling nature of the system 700 assists in this light flux leveling process.

The portion of light ray 722 polarized in the block or y-direction, and similar rays close to normal incidence, are strongly reflected by the film 712 towards the back reflector 714. The diffusing back reflector 714 redirects some of this light at high angles θ towards the film 718 where it is substantially transmitted. Any portion of light ray 722 that is directed back near normal incidence will repeat this process with more light eventually being transmitted through the film 712 at positions more distant from the source than directly above it. More accurate transmission amount as a function of distance can be estimated by commonly available ray tracing programs.

Another embodiment of a multilayer optical film suitable for use as a high transmission flux leveling film uses sPS for one of the polymers in the alternating stack and Kraton G1657 for the other polymer. These polymers are also compatible for coextrusion and exhibit excellent inter-layer adhesion. The Kraton polymer has a refractive index of about 1.488.

This embodiment was actually fabricated by coextrusion with the feedblock technique and subsequently oriented in a tenter at 125 degrees C. with a 5:1 stretch ratio. 550 total layers were coextruded, with no layer multipliers being used but with one optically thick protective boundary layer (PBL) being included to separate the microlayers into two packets. The total number of microlayers was thus about 550.

FIG. 8 plots the measured percent transmission of the film as a function of wavelength, where curve 810 is for normal incidence and polarized along the block axis, and curve 812 is for p-polarized light incident in the block plane at 60 degrees incidence (θ=60). Although the film was made with a layer thickness gradient, the significant ripples in the curves reveal that the thickness gradient was not ideal. Even though the spectra may not be smooth enough for a commercial product, they can be smoothed in production using the axial rod technique disclosed in U.S. Pat. No. 6,783,349 (Neavin et al.). Despite the imperfections of the film sample, the spectra 810, 812 demonstrate that (1) the film has a relatively high reflectivity and low transmission over most visible wavelengths for normally incident light polarized along the block axis, and (2) the transmission substantially increases for p-polarized light at 60 degree incidence in the block plane.

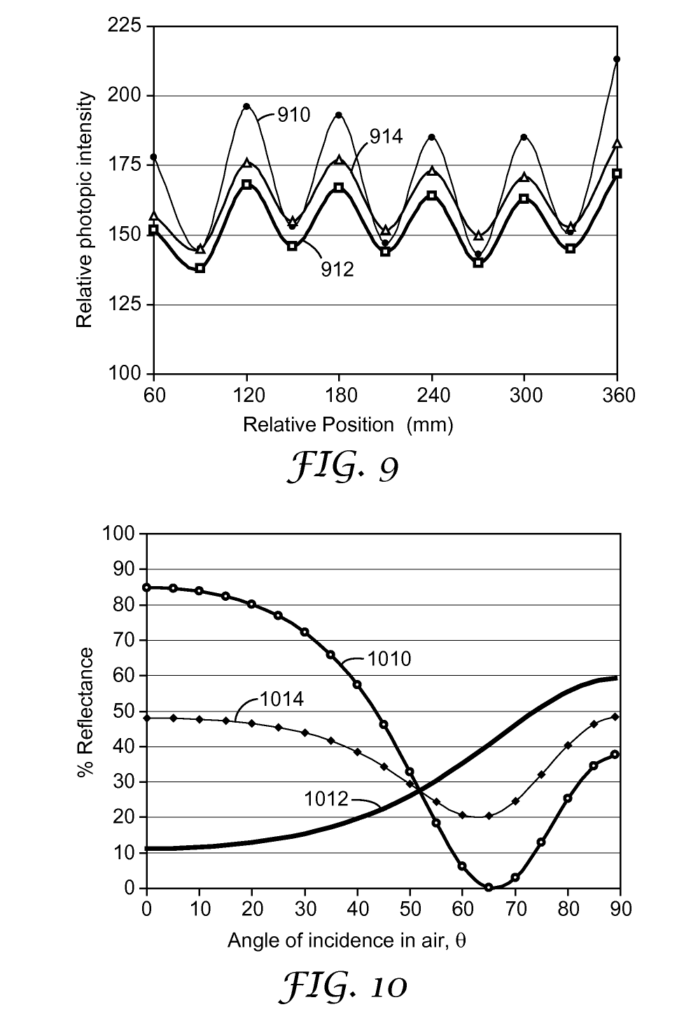

This multilayer optical film was then laminated to one side of a 2 mm thick diffuser plate of the type used in LCD TV backlights. The transmission of the bare diffuser plate was about 75%. The film/plate laminate was placed over an LCD TV backlight which was lit with 6 ccfl (cold cathode fluorescent lamp) bulbs spaced 60 mm apart. The film side of the plate faced the bulbs. The back reflector in the backlight was a white reflector with the trade name MCPET from Furakawa Co, Japan. The bulbs were 3 mm in diameter and the bottom surface of the bulbs was set at 2 mm above the MCPET. The distance from the MCPET to the film surface was 22 mm. A control sample of (1) only the diffuser plate was prepared and also (2) a diffuser plate with the laminated multilayer optical film, and (3) a diffuser plate with the multilayer optical film with a gain diffuser film laminated to the multilayer film. Each of these plates was placed over the backlight and the resulting flux uniformity measured. The intensity of light at the exit side of the diffuser plate was measured with a small silicon photo-detector that was covered with a photopic filter. The detector was placed against the surface of the plate in positions above each bulb and at the points midway between the bulbs. The sample with the gain diffuser sheet was prepared to test the case of immersion in a higher index medium. The intensity vs. position data is plotted in FIG. 9 for all three diffuser plate constructions, where curve 910 is for the diffuser plate only, curve 912 is for the diffuser plate with the laminated multilayer optical film only, and curve 914 is for the diffuser plate with both multilayer film and gain diffuser film laminated. Both samples with the multilayer film show a reduction in intensity variation of about 50% compared to the bare diffuser plate. The sample with the additional film of beaded gain diffuser was initially expected to further reduce the intensity variation, but did not. Further modeling shows that one reason for this is the index mismatch between the in-plane indices of the sPS and the Kraton polymer along the pass axis. The sPS was not heat set and has a stretch axis index of about 1.52, whereas the Kraton polymer has an index of slightly less than 1.49.

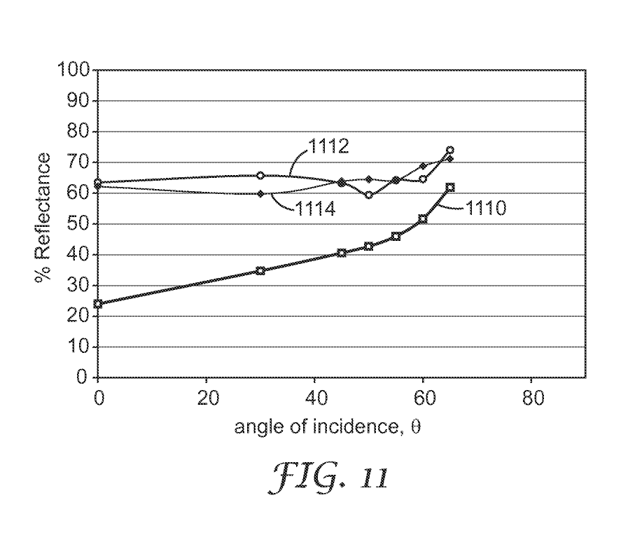

This modeling was pursued further. A stack of 550 layers of sPS and the Kraton polymer was modeled as being immersed in a medium of index 1.2, and the reflectivity calculated as before except that all incident angles were now measured in the 1.2 index medium. The calculated reflectivites for light incident in the block plane, without including any outer surface reflection effects, are shown in FIG. 10, where curve 1010 is for p-polarized light, curve 1012 is for s-polarized light, and curve 1014 is the average. The increase in reflectivity of s-polarized light (curve 1012) at 65 degree incidence angle negates the decrease in reflectivity of p-polarized light (curve 1010) that was obtained by the immersion of the film in a higher index medium via the addition of the beaded gain diffuser. This demonstrates the importance of achieving a relatively close index match of in-plane indices along the pass axis. Immersion of the film in a higher index medium via microstructured coatings can then be used to enhance the performance of the film.

Along the block axis of this multilayer optical film, the adjacent microlayers preferably have an in-plane mismatch (Δny) that is equal to or smaller than the z-index difference (Δnz) This design produces a significant Brewster minimum in reflectivity for p-polarized light in the plane of the block axis.

To further illustrate the performance of this system, the reflectivity of the diffuser plate and the diffuser plate with films laminated, described above, were measured as a function of angle of incidence with a spectrophotometer. The measurements were obtained with a Perkin Elmer 950 spectrophotometer equipped with an integrating sphere and detector. The reflectivity values near normal incidence were obtained by placing the samples on the back port of the sphere and measuring the reflectivity in the usual manner. To measure the reflectivity of the samples at oblique angles, an in-sphere technique was used. Using the same integrating sphere, the sample is placed on a rotatable sample holder in the center of the sphere where the incoming beam strikes the sample at the chosen angle. Reflected light was collected by the sphere while the transmitted light was absorbed by a black film placed behind the sample. This technique was calibrated by measuring the reflectivity of a highly reflective semi-specular reflecting film which was made by coating a film of ESR (Enhanced Specular Reflector, available from 3M Company) with a layer of light scattering beads. The reflectivity of this coated film was about 97% (+/−2%) at all angles of incidence. The average spectral reflectance (averaged from 420 to 680 nm) of the samples is plotted versus angle of incidence in air in FIG. 11. In the figure, curve 1110 is for the diffuser plate alone, curve 1112 is for the diffuser plate with the laminated multilayer optical film only, and curve 1114 is for the diffuser plate with both multilayer film and gain diffuser film laminated.

The reflectivity of the diffuser plate alone increases with angle of incidence, whereas the reflectivity of the other two constructions is about constant with angle of incidence. The ratio of (reflectivity at 60 degrees) to (reflectivity at 0 degrees) is much lower when the diffuser plate is covered with one or both films:the ratio for the diffuser plate alone is 2.15; the ratio for the diffuser plate laminated with the multilayer optical film only is 1.02; and the ratio for the diffuser plate laminated with both the multilayer film and the gain diffuser film is 1.11. In the backlight system, areas midway between the CCFL bulbs corresponds to an angle of incidence on the plate of about 60 degrees. The differences observed in the 60/0 degree ratios for the various diffuser plate constructions is consistent with the observed increase in uniformity of light intensity transmitted through the diffuser plate as a function of distance from the bulb.

Unless otherwise indicated, all numbers expressing quantities, measurement of properties and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Various modifications and alterations of this invention will be apparent to those skilled in the art without departing from the scope and spirit of this invention, and it should be understood that this invention is not limited to the illustrative embodiments set forth herein. All U.S. patents, patent application publications, and other patent and non-patent documents referred to herein are incorporated by reference, to the extent they are not inconsistent with the foregoing disclosure.

1. A reflective film, comprising:
a plurality of microlayers arranged into optical repeat units for reflecting light over an extended wavelength band, adjacent microlayers having substantially matched refractive indices along an in-plane pass axis and having substantially mismatched refractive indices along an in-plane block axis, such that for normally incident light in the extended wavelength band, the film has a transmission Tpassnormal greater than 70% for light polarized along the pass axis and has a transmission Tblocknormal less than 20% for light polarized along the block axis;
wherein each optical repeat unit includes a first microlayer that is negatively birefringent;
wherein adjacent microlayers have substantially mismatched refractive indices along an out-of-plane z-axis, the z-axis refractive index mismatch having the same polarity as the block axis refractive index mismatch and being large enough so that an average transmission of unpolarized light in the extended wavelength band incident in a block plane that includes the block axis increases from Tnormal-unpol at normal incidence to Toblique-unpol at an angle θoblique; and
wherein Toblique-unpol=F1*Tnormal-unpol, and F1>1.

2. The film of claim 1, wherein Tpassnormal, Tblocknormal, Tnormal-unpol, and Toblique-unpol each include effects of two film/air interfaces.

3. The film of claim 1, wherein Tpassnormal, Tblocknormal, Tnormal-unpol, and Toblique-unpol each include no effects of any film/air interface.

4. The film of claim 1, wherein the extended wavelength band is the visible spectrum from 400 to 700 nm, and wherein Tpassnormal, Tblocknormal, Tnormal-unpol, and Toblique-unpol are each averages over the visible spectrum.

5. The film of claim 1, wherein a transmission of p-polarized light in the extended wavelength band incident in the block plane increases from Tblocknormal at normal incidence to Toblique-ppol at the angle θoblique, Toblique-ppol being at least F2*Tblocknormal, where F2 is at least 2.

6. The film of claim 5, wherein a transmission of s-polarized light in the extended wavelength band incident in the block plane monotonically decreases from near normal incidence to the angle θoblique.

7. The film of claim 5, wherein F1 is at least 1.4.

8. The film of claim 5, wherein F1 is at least 1.5 and F2 is at least 3.

9. The film of claim 1, wherein an average transmission of unpolarized light in the extended wavelength band incident in a pass plane perpendicular to the block plane monotonically decreases from normal incidence to the angle θoblique.

10. The film of claim 9, wherein a transmission of s-polarized light in the extended wavelength band incident in the pass plane monotonically decreases from normal incidence to the angle θoblique.

11. The film of 1, wherein the first microlayer comprises syndiotactic polystyrene (sPS).

12. The film of claim 1, wherein each optical repeat unit includes a second microlayer that is isotropic.

13. The film of claim 12, wherein the second microlayer comprises polypropylene.

14. A lighting system comprising the reflective film of claim 1.

15. The system of claim 14, further comprising:
a back reflector disposed to form a recycling cavity with the reflective film.

16. The system of claim 14, further comprising:
a plurality of light sources disposed behind the reflective film;
wherein a spacing between the light sources and the reflective film is selected to enhance brightness uniformity of the light source.

17. The system of claim 14, further comprising:
a light source extending along a length axis and disposed behind the reflective film;
wherein the reflective film is oriented such that the block axis is substantially perpendicular to the length axis.

18. The reflective film of claim 1 in combination with a diffuser.

19. The combination of claim 18, wherein the reflective film attaches to the diffuser with no intervening air gap.

20. The combination of claim 18, wherein the diffuser substantially scrambles polarization.

21. The combination of claim 18, wherein the diffuser comprises a volume diffuser.

22. The reflective film of claim 1 in combination with a linear prismatic film coupled to the film, wherein the prisms extend parallel to a prism axis, and wherein the prism axis of the prismatic film is substantially perpendicular to the block axis of the reflective film.
